(19) United States
(12) Patent Application Publication
(10) Pub. No.: US 2005/0180589 A1
(43) Pub. Date: Aug. 18, 2005

(54) Speaker

(76) Inventor: Nien-Tu Liu, Taipei City (TW)

Correspondence Address: TROXELL LAW OFFICE, SUITE 1404, 5205 LEESBURG PIKE, FALLS CHURCH, VA, 22041, US

(21) Appl. No.: 11/033,397

(22) Filed: Jan. 12, 2005

(30) Foreign Application Priority Data
Jan. 14, 2004 (TW) 093200642

(51) Int. Cl. H04R 1/02; H04R 1/20

(52) U.S. Cl. 381/338; 381/353

(57) ABSTRACT

A speaker comprises at least one long round shape resonance tube, in which comprises at least one speaker with at least one signal line disposed at one end of the resonance tube.

### BACKGROUND OF THE INVENTION

1. Field of the Invention

The present invention relates to a speaker, and particularly the present invention relates to a speaker which comprises at least one long round shape resonance tube, by way of using this long round shape resonance tube can improve the low frequency effect of the speaker and lessen the weight of the speaker.

2. Description of Related Art

Accompanying the multi-media computer becoming more popularly, the user generally places two speakers beside computer to listen to the music outputted from the CD player built in the computer. Please refer to FIG. 1, which shows how a prior art speaker connects to a computer. As shown in FIG. 1, the prior art portable speaker 70 generally comprises a speaker unit 71 and a housing 72. The portable speaker 70 can connect to an amplifier (or computer) 80 through an AV line 73. However, the prior art portable speaker 70 generally has single channel, so if user wants to listen to a stereo music, it must connect two separate portable speakers 70 to the amplifier (or computer) 80, therefore it brings some inconveniences to the user.

In the prior Taiwan issued patent No. 515619 filed Jul. 25, 2001, there is disclosed a USB portable amplifying speaker. Please refer to FIG. 2, which shows how the USB portable amplifying speaker connects to a computer. As shown in FIG. 2, the free end of the power cable of the speaker unit 91 is designed into a USB plug 92 for connecting to the USB port 105 of the PC or notebook computer 100 so as to directly drive the low-voltage amplifier built in the speaker unit 91 by way of using the DC 5V power supplied by the USB port 105, thereby the audio signal outputted from the PC or notebook computer 100 can amplify by the low-voltage amplifier drove by DC 5V power and output through the amplifier. But the portable amplifying speaker of the prior patent still belongs to the separate assembly type speaker, therefore, the PC or notebook computer 100 still requires connecting two separate speakers, respectively.

There is therefore a need for a new and improved strategy and technique for overcoming these deficiencies and the present invention overcomes these deficiencies in a new and novel fashion.

### SUMMARY OF THE INVENTION

The present invention generally relates to a strategy and a technique which overcomes some or all of the above referenced deficiencies associated with prior portable speaker.

It is a first non-limited object of the present invention is to provide a speaker which comprises at least one long round shape resonance tube, by way of using this long round shape resonance tube can improve the low frequency effect of the speaker and lessen the weight of the speaker.

According to a first non-limited object of the present invention, a speaker is provided and comprises at least one long round shape resonance tube, in which comprises at least one speaker with at least one signal line disposed at one end of the resonance tube.

### BRIEF DESCRIPTION OF THE DRAWINGS

The present invention can be more fully understood by referring to the following description and accompanying drawings, in which:

FIG. 1 is the prospective view which shows how a prior art speaker connects to a computer;

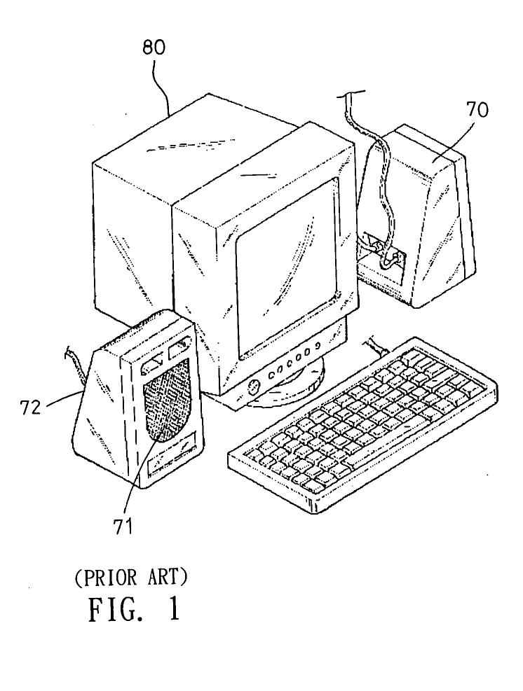

FIG. 2 is the prospective view which shows how the USB portable amplifying speaker connects to a computer;

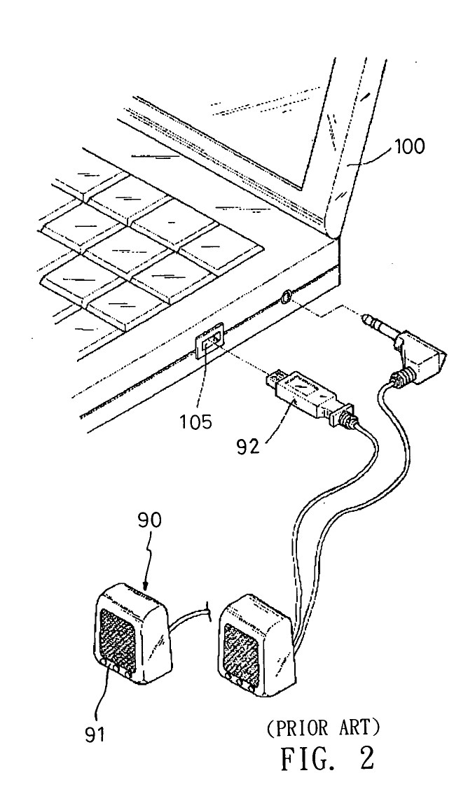

FIG. 3 is the prospective view which shows how a speaker connects to a computer according to one preferred embodiment of the present invention; and

FIG. 4 is the prospective view which shows how a speaker connects to a computer according to another preferred embodiment of the present invention.

### DETAILED DESCRIPTION OF THE PREFERRED EMBODIMENTS

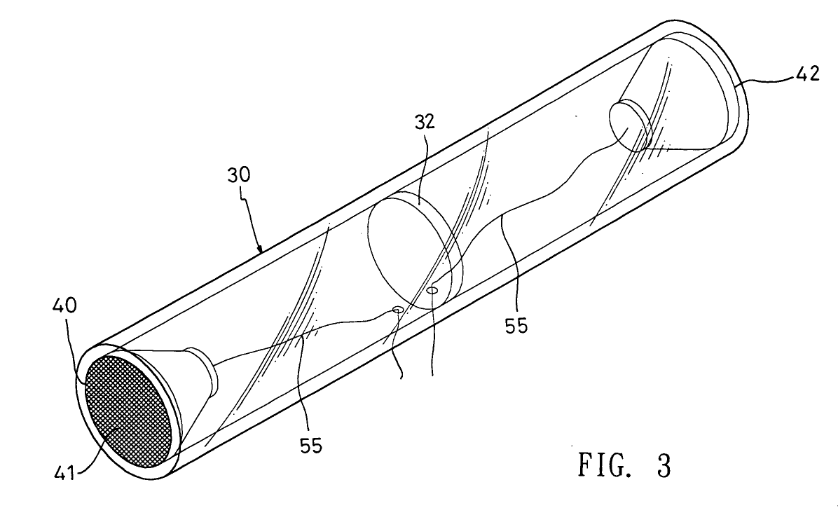

Referring to FIG. 3, which shows how a speaker connects to a computer according to one preferred embodiment of the present invention. As shown in FIG. 3, the speaker of the present invention comprises at least one long round shape resonance tube 30, in which comprises at least one speaker 40 with at least one signal line 55 disposed at one end of the resonance tube 30. Wherein, the length of the long round shape resonance tube 30 is longer than it's diameter, the purpose of this is to eliminate the phase delay of the back wave of the speaker 40 such that the low-frequency effect can be improved. The long round shape resonance tube 30 is made of transparent material, for example but not limited to an acrylic plastic material so as to improve the appearance of the speaker 40. In one non-limiting embodiment of the present invention, the two ends of the long round shape resonance tube 30 is disposed a speaker 40,41, respectively so as to let the speaker of the present invention can play stereo music. The number of the long round shape resonance tube 30 is two or more, therefore, the speaker 40 of the present invention can output high frequency, middle frequency and low frequency sound signal or music respectively after frequency filtering.

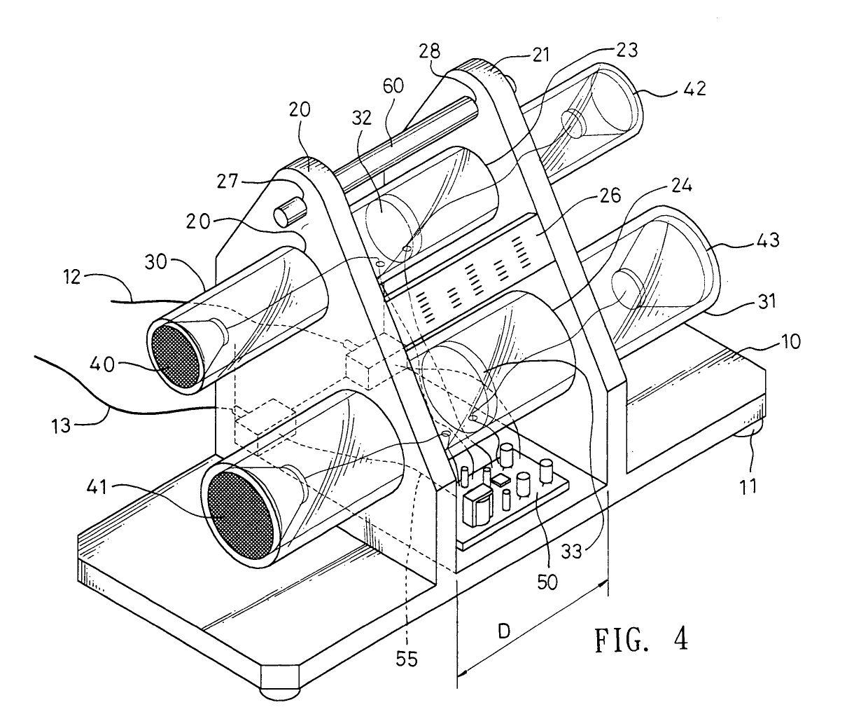

Referring to FIG. 4, which shows how a speaker connects to a computer according to another preferred embodiment of the present invention. As shown in FIG. 4, the speaker of the present invention further comprises: a base 10; at least one frame 20; and a handle 60, thereby assembling the base 10, at least one frame 20 and handle 60 together to form a portable speaker.

Wherein the base 10 and frame 20 are made of transparent material, for example but not limited to an acrylic plastic material so as to improve the appearance of the speaker.

Wherein, it further comprises at least one pad 11 disposed below the base 10 so as to let the portable speaker of the present invention can be placed on a surface smoothly. The speaker of the present invention further comprises a plurality of signal terminals 12 and a power jack 13 disposed behind the base 10. Wherein the plurality of signal terminals 12 are AV terminals, preferably so as to conveniently the user connect the speaker to an audio signal player for example but not limited to a CD player (figure not shown), while the power jack 13 is used for connecting to a power supply (figure not shown) for getting the power.

In one non-limiting embodiment of the present invention, the at least frame 20 preferably comprises two frames 20, 21 and it further comprises a partition D located between the frames 20, 21. The frame 20, 21 is disposed and fixed on the base 10, respectively. The frame 20 further comprises openings 22, 23, while the frame 21 further comprises openings 24, 25, wherein the shapes of the openings 22, 23, 24, 25 are for example but not limited to a round. Furthermore, it further comprises a power level indicator 26 deposited in front of the frames 20, 21 for indicating the power level of the audio signal. Wherein, the power level indicator 26 is preferably consisted of LEDs, such as a Chip On Board (COB) LED display.

In one non-limiting embodiment of the present invention, the speaker preferably comprises two long round shape resonance tubes 30, 31 which are passed through the openings 22, 23, 24, 25 and fixed on the openings 22, 23, 24, 25, respectively. One of the benefits of using the long round shape resonance tubes 30, 31 is that the phase delay of the back wave of the speaker 40 can be eliminated such that the low-frequency effect of the speaker can be improved. Furthermore, the long round shape resonance tubes 30, 31 further comprise a partition 32, 33 located at about the center of the long resonance tube30, 31, respectively.

In one non-limiting embodiment of the present invention, it preferably comprises four speakers 40, 41, 42, 43. Wherein, the speaker 40 is a high frequency speaker of the left channel; speaker 41 is a middle-low frequency speaker of the left channel; speaker 42 is a high frequency speaker of the right channel; and speaker 43 is a middle-low frequency speaker of the right channel. The high frequency speakers 40, 42 are disposed beside the long round shape resonance tube 30, respectively; while the middle-low frequency speakers 41, 43 are disposed beside the long round shape resonance tube 31, respectively.

Furthermore, the base 10 further comprises an amplifying circuit 50 and a plurality of signal lines 12. Wherein one end of the amplifying circuit 50 is coupled to an audio source player (such as a CD player built in a computer or a standalone CD player, figure not shown), and another end of the amplifying circuit 50 is coupled to the speakers 40, 41, 42, 43 through the signal lines 12, such that the magnified audio signal outputted from the audio source player can be outputted through the speaker 40, 41, 42, 43.

It further comprises an opening 27, 28 disposed on the frame 20, 21, respectively, and the opening 27, 28 are preferably disposed at the top portion of the frame 20, 21, respectively. Thereby, a handle 60 can be passed through the openings 27, 28 and then fix by way of using a screw (figure not shown) so as to form a portable speaker and easily user carry.

While the invention has been described with reference to preferred embodiment thereof, it is to be understood that modifications or variations may be easily made without departing from the spirit of this invention, which is defined by the appended claims.

1. A speaker comprising:
at least one long round shape resonance tube, in which comprises at least one speaker with at least one signal line disposed at one end of said resonance tube.

2. The speaker as claimed in claim 1, wherein it further comprises a partition located at about the center of said long resonance tube.

3. The speaker as claimed in claim 2, wherein it further comprises:
a base; and
at least one frame positioned and fixed on said base, having at least one opening for providing said long round shape resonance tube passed therein.

4. The speaker as claimed in claim 3, wherein said at least one frame further comprises an opening, and can pass a handle through said opening and then fix by way of using a screw so as to form a portable speaker.

5. The speaker as claimed in claim 3, wherein said base further comprises an amplifying circuit, wherein one end of said amplifying circuit is coupled to an audio source player, and another end of said amplifying circuit is coupled to said speaker by a plurality of signal lines, so that the magnified audio signal outputted from said audio source player can be outputted through said speaker.

6. The speaker as claimed in claim 1, wherein said long round shape resonance tube is made of transparent material.

7. The speaker as claimed in claim 3, wherein the number of said frame is two, and further comprises a partition disposed between said two frames, wherein each frame has two openings, respectively.

8. The speaker as claimed in claim 7, wherein the number of said long round shape resonance tube is two, and each long round shape resonance tube is passed through said two openings of said frame, respectively.

9. The speaker as claimed in claim 1, wherein said speakers are disposed at two ends of said long round shape resonance tube, respectively.

10. The speaker as claimed in claim 3, wherein it further comprises at least one pad disposed below said base.

11. The speaker as claimed in claim 3, wherein it further comprises a power level indicator disposed in front of said frame.

12. The speaker as claimed in claim 11, wherein said power level indicator is consisted of LEDs.

13. The speaker as claimed in claim 12, wherein said power level indicator is a Chip On Board LED display, preferably.

14. The speaker as claimed in claim 3, wherein it further comprises a plurality of signal terminals and a power jack disposed on said base.

15. The speaker as claimed in claim 1, wherein said speaker is a high frequency speaker.

16. The speaker as claimed in claim 1, wherein said speaker is a middle-low frequency speaker.

17. The speaker as claimed in claim 1, wherein the length of said long round shape resonance tube is longer than it's diameter.
